(19) United States
(12) Patent Application Publication
(10) Pub. No.: US 2026/0144249 A1
(43) Pub. Date: May 28, 2026

(54) AN IMPROVED BIOPESTICIDE

(71) Applicant: ECOSPRAY LTD, St Edmunds (GB)

(72) Inventors: Murree Richard GROOM, Suffolk (GB); Awais ANWAR, Suffolk (GB)

(21) Appl. No.: 19/122,852

(22) PCT Filed: Oct. 19, 2023
(86) PCT No.: PCT/GB2023/052714

§ 371 Date: Apr. 21, 2025

(30) Foreign Application Priority Data
Oct. 20, 2022 (GB) 2215494.2

(51) Int. Cl. A01N 25/04; A01N 25/12; A01N 31/02; A01N 41/12; A01N 65/42; A01P 5/00; A01P 21/00

(52) U.S. Cl. CPC A01N 25/04; A01N 25/12; A01N 31/02; A01N 41/12; A01N 65/42; A01P 5/00; A01P 21/00

(57) ABSTRACT

Disclosed is a pesticide having a polysulphane as active agent, and being either synthetically prepared or derived from garlic oil. The active is held as a disperse oil phase within an aqueous continuous phase. A surfactant, typically comprising a carbohydrate fatty acid ester is employed to retain the two-phase system. The diameter of the emulsion droplets, and/or the surface area of the emulsion system, is controlled to optimise the effectiveness of the pesticide contained therein. Also disclosed is a granule having an inert carrier matrix such as a diatomaceous earth or a cellulosic material, for example wood cellulose, in which the poly sulphane-containing emulsion is supported. The use of emulsion containing granules in soils to release pesticide in a controlled manner into soil is also disclosed. Also disclosed is the use of the emulsion system for accelerating breaking of bud dormancy.

### FIELD OF THE INVENTION

The present invention relates to improved formulations for the delivery of a biopesticide, said biopesticide being primarily derived from garlic oil and synthetic analogues thereof. In addition, methods of producing and uses of said formulations are disclosed.

### BACKGROUND TO THE INVENTION

Given the continued increase in world population, the requirement to increase food output becomes more pressing. This leads usually to more intensive farming methods in which crop rotation and fallow agricultural land become used less and less, which in turn give rise to difficulties of a higher risk of infestation from pests which are adapted, especially in a parasitic relationship, to a particular crop.

One crop with which the present disclosure is concerned, although not exclusively, is the potato. This can become infested with roundworms of the genus globodera, and which are commonly referred to as potato cyst nematodes (PCN). Serious infestations can result in up to 90% crop loss and the PCN is estimated to cause losses of around £40,000,000 in the UK alone.

A number of methods and products can be employed, which are only partially successful in combating PCN. Firstly, as mentioned above crop rotation is used, although this normally means a gap of at least six years between plantings of a susceptible crop. Alternatively, catch crops can be used which aim to attract the pests and which are then subsequently, at the height of infestation, destroyed. This is quite an expensive method to carry out and is only relatively effective. Thirdly, chemical agents have been developed based, for example, around carbamates. As examples of these can be mentioned Aldicarb (marketed under the trade name “Temik”) and Oxamyl (marketed under the trade name “Vydate”).

A number of problems attach to this form of control, however. There is evidence that the degradation time of the carbamate decreases with repeated short-time use, and hence the effectiveness is reduced. Secondly, legislation is increasingly restricting the use of pesticides and it is expected that the use of some will become illegal in the near future.

There is therefore both a need and a desire for pest control products which are derived from or based on naturally occurring materials.

One such set of products are those derived from garlic, such as garlic oil and also synthetic analogues of active compounds in garlic, such as the polysulphanes (also commonly referred to as polysulphides) disclosed in WO 08/59217. With these compounds, the main problems to be overcome are delivery of the active at the correct time; and that said delivery is sustainable. One means of addressing these criteria is to incorporate the active compounds within a granule. The compounds are then eluted from the granule by rainwater or applied water. However, in the case of some synthetic analogues the problem is encountered that compounds including a sulphur chain of four or more atoms are relatively water insoluble and so are not readily eluted.

In addition, typically only 15% of product can be eluted with the remainder being relatively strongly held within the granule and unavailable for use.

It is an object of the current invention to provide a biopesticide formulation and delivery means therefor which addresses the above problems.

### SUMMARY OF THE INVENTION

According to a first aspect there is provided a biopesticide emulsion system having a first continuous phase comprising water and a second discontinuous phase comprising a biopesticide derived from a concentrated liquid garlic juice, a synthetic polysulphane or mixture thereof, and including an emulsifying agent to retain the two phase system. The emulsion enables the pesticide to be more effectively and efficiently delivered.

The diameters of the emulsion droplets of the discontinuous phase are preferably less than 2.4 μm, more preferably less than 2.0 μm, less than 1.5 μm, less than 1.3 μm or about 1 μm. These particular diameters provide increased mortality when employed against a target pest. These particular diameters provide accelerated breaking of bud dormancy when employed on plants.

The specific surface area of the emulsion is preferably more than 200,000 cm²/mL, more preferably more than 250,000 cm²/mL, more than 300,000 cm²/mL or more than 350,000 cm²/mL. These particular specific surface areas provide increased mortality when employed against a target pest. These particular specific surface areas provide accelerated breaking of bud dormancy when employed on plants.

The emulsifying agent is advantageously an esterified carbohydrate. Particularly advantageously, the carbohydrate is sorbitan. Especially advantageously, the sorbitan ester is polyethoxylated to increase the HLB value. A preferred emulsifying agent is Tween™ 20 which produces, when using the above pesticides, emulsions having the desired droplet size and/or the desired specific surface area.

Tween®20 is an established product used in biological applications with which the skilled reader would be familiar. It is a polyoxyethylene sorbitol ester that belongs to the polysorbate family. It is a nonionic detergent having a molecular weight of 1,225 daltons, assuming 20 ethylene oxide units, 1 sorbitol, and 1 lauric acid as the primary fatty acid. The ethylene oxide subunits are responsible for the hydrophilic nature of the surfactant, while the hydrocarbon chains provide the hydrophobic environment. Sorbitol forms the backbone ring to which the ethylene oxide polymers are attached.

In an alternative embodiment, the emulsifying agent is a sucrose ester, such as sucrose stearic acid SP70. Preferably the sucrose ester has a hydrophilic-lipophilic balance (HLB) value of at least 15 or at least 16.

The level of emulsifying agent present is conveniently less than 8% w/w, for example, less than 6% w/w, or less than 5% w/w, or less than 3% w/w, and especially conveniently less than 2% w/w of the emulsion system. The level is further conveniently greater than 0.25% w/w to ensure good emulsion droplet size of the discontinuous phase and/or a desired specific surface are of the emulsion system.

The percent w/w ratio of continuous to discontinuous phase is preferably greater than 20:1 and especially preferably greater than 30:1.

In an embodiment, there is provided an emulsion system as described above for accelerating breaking of bud dormancy.

According to a second aspect there is provided a granular pesticide comprising a granular matrix, said granular matrix retaining a biopesticide emulsion having a first continuous phase comprising water and a second discontinuous phase comprising a biopesticide derived from a concentrated liquid garlic juice, a synthetic polysulphane or mixture thereof, and including an emulsifying agent to retain the two phase system.

The diameters of the emulsion droplets of the discontinuous phase are preferably less than 2.4 μm, less than 2.0 μm, less than 1.5 μm, less than 1.3 μm or about 1 μm.

The specific surface area of the biopesticide emulsion is preferably more than 200,000 cm²/mL, more preferably more than 250,000 cm²/mL, more than 300,000 cm²/mL or more than 350,000 cm²/mL. These particular specific surface areas provide increased mortality when employed against a target pest. These particular specific surface areas provide accelerated breaking of bud dormancy when employed on plants.

The emulsifying agent is advantageously an esterified carbohydrate. Particularly advantageously, the carbohydrate is sorbitan. Especially advantageously, the sorbitan ester is polyethoxylated to increase the HLB value. A preferred emulsifying agent is Tween™ 20 which produces, when using the above pesticides, emulsions having the desired droplet size and/or the desired specific surface area.

The level of emulsifying agent present is conveniently less than 8% w/w, for example, less than 6% w/w, or less than 5% w/w, or less than 3% w/w, and especially conveniently less than 2% w/w of the emulsion system. The level is further conveniently greater than 0.25% w/w to ensure good emulsion droplet size of the discontinuous phase and/or the desired specific surface area.

The percent w/w ratio of continuous to discontinuous phase is preferably greater than 20:1 and especially preferably greater than 30:1.

The emulsion is preferably present at a ratio of 0.5% w/w-1.0% w/w to the granular matrix.

The granular matrix is advantageously selected from a diatomaceous earth or alternatively from a cellulosic material, especially advantageously a wood cellulose.

According to a third aspect there is provided a method of manufacture of a granular biopesticide comprising the steps of:
producing an emulsion of a biopesticide in water;
selecting a granular matrix material and;
mixing said emulsion with the granular matrix material to absorb the emulsion within the matrix, wherein the biopesticide is derived from a concentrated liquid garlic juice, a synthetic polysulphane or mixture thereof.

In some embodiments, production of the emulsion comprises a step of blending at a speed of at least 2000 rpm, at least 3000 rpm, at least 4000 rpm, at least 6000 rpm or at least 8000 rpm; or at about 3000 rpm, about 4000 rpm, about 6000 rpm or about 8000 rpm.

The diameters of the emulsion droplets of the discontinuous phase are preferably less than 2.4 μm more preferably less than 2.0 μm, less than 1.5 μm, less than 1.3 μm or about 1 μm.

The specific surface area of the biopesticide emulsion is preferably more than 200,000 cm²/mL, more preferably more than 250,000 cm²/mL, more than 300,000 cm²/mL or more than 350,000 cm²/mL. These particular specific surface areas provide increased mortality when employed against a target pest. These particular specific surface areas provide accelerated breaking of bud dormancy when employed on plants.

According to a fourth aspect there is provided the use of a granular biopesticide composition, wherein the granular biopesticide composition includes a granular matrix and an emulsified biopesticide absorbed within said matrix wherein the biopesticide is derived from a concentrated liquid garlic juice, a synthetic polysulphane or mixture thereof.

In an embodiment, there is provided use of the granular biopesticide as described above for accelerating breaking of bud dormancy.

### BRIEF DESCRIPTION OF THE DRAWINGS

The description is illustrated with respect to the drawings which illustrate results obtained is in the preparation and effectiveness of the disclosed invention. In the drawings:

FIG. 1 illustrates the relationship between droplet size of an emulsion and mortality rate;

FIG. 2 illustrates the effect of Tween™ concentration and the effect of blending speed on the mortality rate of the produced emulsion;

FIG. 3 illustrates droplet diameter produced in a synthetic garlic oil emulsion system;

FIG. 3a illustrates effect of homogeniser speed on emulsions form from natural garlic using 1% Tween™20;

FIG. 4 illustrates the effect of surfactant concentration on droplet size;

FIG. 5 illustrates the effect of emulsification speed on mortality rate using a synthetic garlic oil;

FIG. 6 illustrates the mean particle size of several emulsion systems.

FIG. 7 illustrates the specific surface area of several emulsion systems.

FIG. 8 illustrates the mean nematode mortality at one hour contact for two emulsion systems at various dilutions.

FIG. 9 illustrates the mean nematode mortality at three hours contact for two emulsion systems at various dilutions.

FIGS. 10 and 11 illustrate the elution profile of granules prepared;

FIG. 12 illustrates mortality rate of nematodes using the granules of FIGS. 10 and 11;

FIG. 13 illustrates the mortality rate of elution fractions from the material illustrated in FIG. 10.

FIG. 14 illustrates the concentration of sulphur-containing compounds in the elution cycle of a synthetic polysulphide-containing granule; and

FIG. 15 illustrates the elution pattern obtained from a soil sample containing granules.

### DETAILED DESCRIPTION OF THE INVENTION

The use of granules containing concentrated garlic oil as an active biopesticide is known in the art. In the soil, when applied to combat a perceived pest, the granules are able to release the biopesticide—in the case of garlic oil an active sulphur-containing compound—into the soil, which active compounds either kill, weaken or act as a deterrent towards the pest. The granules are most effective when exposed to water, either through natural rainfall or irrigation, which water acts to transport the active compounds from the granule into the soil. This is believed to be primarily through dissolution of the active compounds, although other mechanisms may be at work.

However, a large proportion of active compounds can remain inside the granule, where it has almost no effect. Moreover, release can be so slow and low that the granules effectiveness is reduced.

The present invention therefore acts to mobilise the active compounds through their emulsification, using water as the continuous phase prior to granulation. Moreover, it has also been found that the emulsified systems bring enhanced effectiveness of the biopesticide, even when the biopesticide is employed without granulation. It has also been found that the emulsified systems bring enhanced effectiveness of the biopesticide for accelerating breaking of bud dormancy, when the biopesticide emulsion is employed without granulation.

### General Preparation of an Emulsion

An example of a method of producing the emulsions the following is provided. It will be recognised by the skilled person, however, that other methodologies for the preparation of an emulsion can be used without departing from the scope of the invention. For example, the emulsifier can be mixed with water followed by addition of the biopesticide. In addition, desired emulsion droplet size and/or desired specific surface area of the emulsion system, can be obtained using any suitable means, for example homogenization, or high shear mixing using, for example, a Silverson™ mixer.

A solution of an emulsifier was produced by dissolving the emulsifier in the biopesticide at 58° C., with stirring. Emulsions were then prepared by pouring the mixture into a small Waring cup and homogenising using a Waring blender. A typical preparation cycle involves the following cycle: blend (low speed) 15 s, rest 30 s, blend (high speed) 15 s, rest 30 s, blend (high speed) 20 s. In some embodiments, preparation of the emulsion involves at least one step of blending at a speed of least 2000 rpm, at least 3000 rpm, at least 4000 rpm, at least 6000 rpm or at least 8000 rpm; or at about 3000 rpm, about 4000 rpm, about 6000 rpm or about 8000 rpm. The finished product was stored in a sealed vial until required.

In order to determine the particle size, approximately 0.5 ml was removed from each sample and diluted to 1.5 ml. The particle size distribution was then determined using a Beckmann Coulter LS13320 Laser Diffraction Particle Size Analyzer.

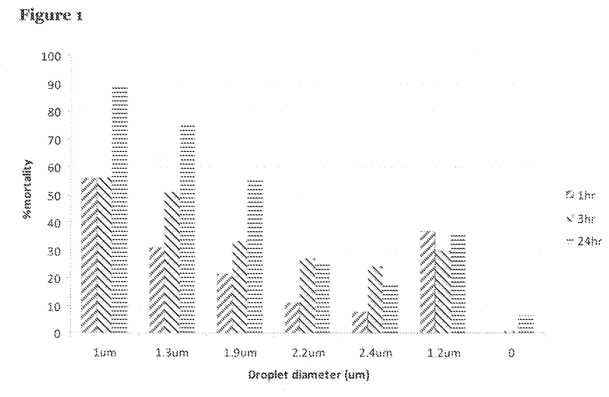

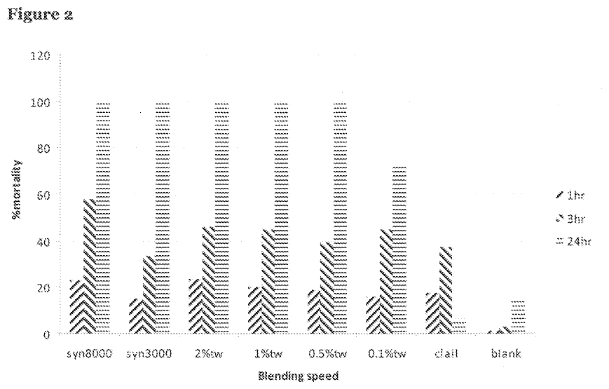

The importance of the disperse phase within the emulsion formed can be clearly seen from FIG. 1. The results shown were obtained from in vitro experiments on the mortality of the emulsion towards nematodes. In the experiments, test solutions (0.9 ml) were dispensed into small tubes. Water (0.1 ml) containing 2-300 nematodes was added to the tube to complete the test volume (1.0 ml). Tests were then run at room temperature at various time intervals: 50 μl aliquots of test solution were removed from the solution for inspection of the nematodes.

FIG. 1 shows emulsions formed from a concentrated garlic oil obtained from natural sources. The relationship of droplet size of the dispersed phase to its effect on mortality of the nematodes can be clearly seen in that smaller droplet size produces a higher rate of and absolute value for mortality. The effect of garlic oil itself, with no added emulsifier is also shown (columns second from right, marked ‘1.2 μm’). The background mortality rate, under the test conditions, without garlic oil present is shown in the final columns on the far right-hand side of the results.

In respect of a synthetic garlic oil, in which the active ingredient is a mixture of diallyl polysulphanes having differing sulphur chain lengths, the effect of Tween™ concentration is shown in FIG. 2. Emulsions for data shown in column sets 3-7 of FIG. 2 were prepared by blending at 8000 rpm. The bioactivity of systems containing 0.5 to 2.0% w/w Tween 20 can be seen to be greater than when the system contains 0.1% w/w Tween™ 20, and all are improved over an emulsion created using natural garlic oil (columns marked ‘clail’).

FIG. 2 also contains data from two samples of emulsions of synthetic garlic oil prepared using 1% Tween™ 20 as surfactant: the first using a homogeniser speed of 8000 rpm (syn8000) (column 1 in FIG. 2) and the second a speed of 3000 rpm (syn3000) (column 2 in FIG. 2).

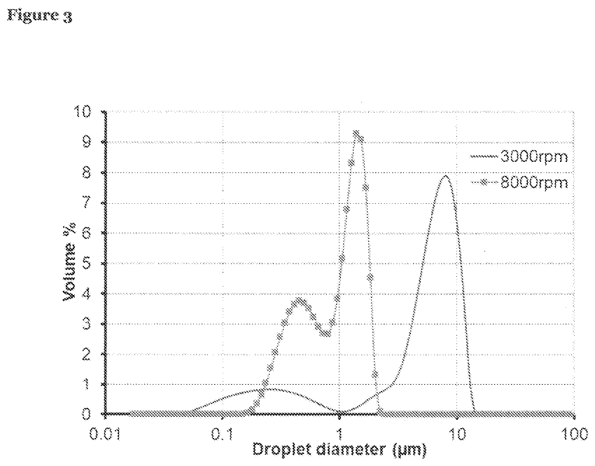

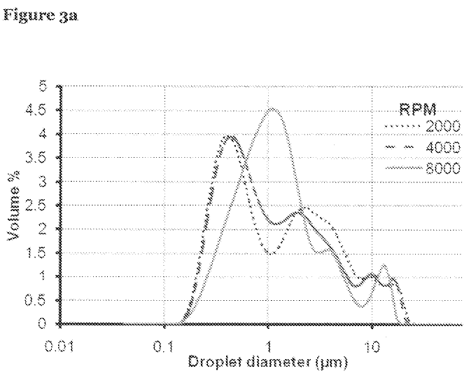

The size distribution of the emulsion produced using a synthetic oil is more varied than that produced using natural garlic oil. FIG. 3 demonstrates this point for the syn3000 and syn8000 emulsions prepared as discussed above. The droplet size of the disperse phase was measured and the results are shown in FIG. 3. As can be seen, the droplet size at 3000 rpm is far greater than that produced using 8000 rpm. This contrasts with the emulsions formed from natural garlic oil which showed little effect of homogeniser speed when using 1% Tween™ 20, as shown in Table 1 below, and in FIG. 3a. Without being bound by theory, this may be caused by the natural garlic oil including compounds (such as carbohydrates) which can act as surfactants in their own rights.

TABLE 1
Emulsion formed from natural garlic oil using 1% Tween ™ 20

| Homogeniser speed | Mean Droplet Diameter (μm) |
|---|---|
| 2000 | 1.25 |
| 4000 | 1.24 |
| 8000 | 1.32 |

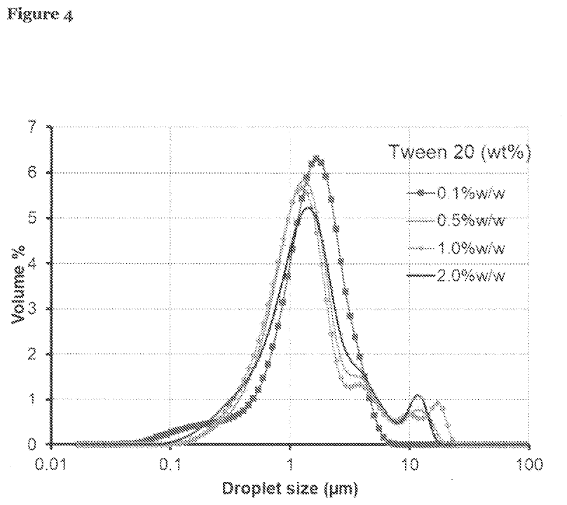

Moreover, Tween™ 20 is effective at producing an emulsion over a range of concentrations. FIG. 4 illustrates droplet size distribution for emulsions prepared using 0.1% w/w-2% w/w Tween® 20. FIG. 4 illustrates that from 0.5 to 2.0% w/w Tween®, the droplet size distribution is relatively constant. There is, however a shift in the position of the maximum peak and particularly when 0.1% w/w Tween™ 20 is used, although the mean droplet diameter actually decreases.

In producing the emulsion, the hydrophile/lipophile balance (HLB) of the surfactant needs to be borne in mind. In general, more lipophilic surfactants, having a low HLB value, tend to be more efficient at producing water in oil emulsions whereas more hydrophilic surfactants tend to produce oil in water emulsions.

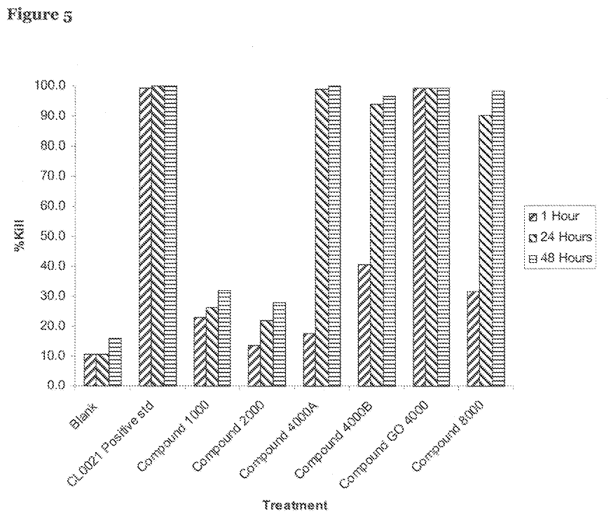

The importance of the physical structure of the active compound is again shown in FIG. 5. A 3% w/w synthetic garlic oil was emulsified using a sucrose stearic acid SP70 (obtained from S.Black limited), and having an HLB value of 15, as surfactant and a range of mixing rates. It is to be expected that other sucrose esters, including mono-, di- and tri-esters would also be applicable as emulsifiers and this would be apparent to the skilled person. In addition, other fatty acids such as lauric, myristic and palmitic, again well known in the art, can be contemplated. The resultant emulsions were then tested as nematicides. An emulsion having processed natural garlic oil (also referred to herein as clail or clail021) was also utilised for comparison (CL00021). Results are shown in FIG. 5. At lower mixing speeds, the bioassays show that the effectiveness of the active against nematodes was relatively local. Above 4000 rpm, however, the effectiveness became almost 100% after 24 hours showing a stepped improvement. Given the effects shown above, in relation to emulsification conditions and droplet size it is likely that an effective size of droplet was produced by the higher rate mixing.

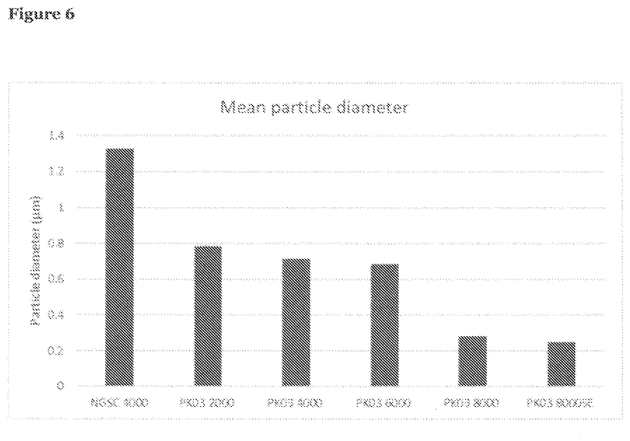

The relationship between droplet diameter and surface area and biological activity was investigated and the results can be seen in FIGS. 6 to 9.

The control was Nemguard SC (CLAIL 0021). Nemguard SC is a concentrated garlic juice containing about 35% w/w water, about 55% w/w/complex carbohydrates, about 3% w/w garlic oil (polysulfide oil); about 7% w/w protein, electrolytes and lipids originating from the garlic plant. The Nemguard SC was blended at about 4000 rpm.

Two test emulsions were prepared, PK03 (Nemguard SUGO (polysorbate)) and PK03 SE (Nemguard SEGO (sucrose ester also added)). The PK03 emulsion comprised about 91% w/w water, about 6% w/w polysorbate 20 and about 3% w/w garlic oil. The PK03 emulsion was blended in a high shear mixer at four different speeds, 2000 rpm, 4000 rpm, 6000 rpm and 8000 rpm. The PK03 SE emulsion comprised about 90% w/w water, about 6% w/w polysorbate 20, about 3% w/w garlic oil and about 1% w/w sucrose ester. The PK03 SE emulsion was blended in a high shear mixer at about 8000 rpm. All of the PK03 and PK03 SE emulsions were very stable—this was demonstrated by a consistency of particle size distributions at various dilutions. A total of five test samples were investigated.

The particle diameter and specific surface area of the emulsion were tested. The process of measurement requires introduction of the test substance to a volume of water in an optical device through which a beam of light is transmitted. The pattern of scattering indicates the size/surface area of droplets in the solution. The level of dilution in the test cell is estimated to be around 0.2-0.5% v/v in water.

FIG. 6 shows that all preparations of PK03 emulsions have a mean particle diameter at least 40% lower than the Nemguard SC prepared at 4000 rpm. The data also show a reducing particle diameter with increasing blending speed and a notable inflexion potin between 6000-8000 rpm to even smaller diameter particles. It is hypothesised that the extra components of natural garlic juice (homogenised proteins, dissolved electrolytes etc) limit the amount of emulsification that can occur and therefore limit the particle diameter that can be obtained for natural garlic juice.

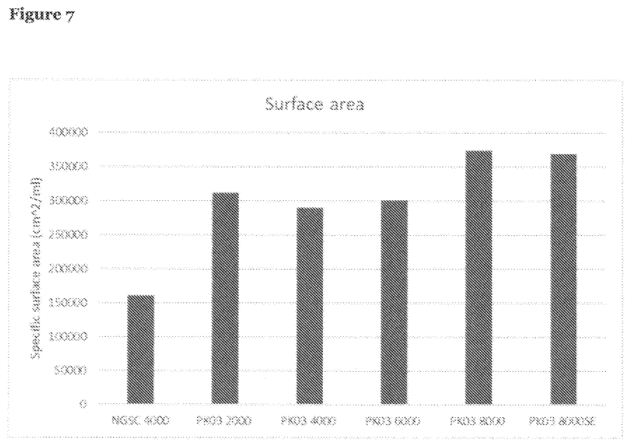

FIG. 7 shows the specific surface area of the emulsion. It can be seen that the surface area of the droplets increase in an inverse relationship to the droplet diameter. The greatest surface areas were generated from the 8000 rpm blending (corresponding to the smallest particle diameter). All PK03 emulsions had droplet surface areas notably greater than the Nemguard SC control.

The ratio of surface area/volume is given by 3/r where r is the radius of the sphere (droplet)—the radius being half of the diameter. Therefore, with r equal to 1, 0.75, 0.5, 0.25, and 0.1, the surface area/volume ratio changes to 3, 4, 6, 12, and 30. It can therefore be seen that a droplet with a radius of 0.5 μm (diameter of 1 μm) has twice the surface area to volume ratio of a droplet with a radius of 1 μm (diameter of 2 μm).

Generally, in biology, a larger surface area to volume ratio is more efficient than a smaller one. This is due to the amount of plasma membrane relative to the volume of the cell. The more plasma membrane available to transport materials in and out of the cell, the more efficient the cell will be in completing specific functions that require transfer across the membrane. The same principles apply with regards to transfer of actives, in the various tested formulations herein, into the cytosol of target organisms to generate cytotoxic effects.

Two of the PK03 test emulsions (Nemguard-SUGO and Nemguard-SEGO-blended at 4000 rpm) were tested for biological activity against nematodes. The emulsions were diluted with water at 0.05% dilution, 0.1% dilution, 0.2% dilution and 0.4% dilution and used in bioassay with nematodes.

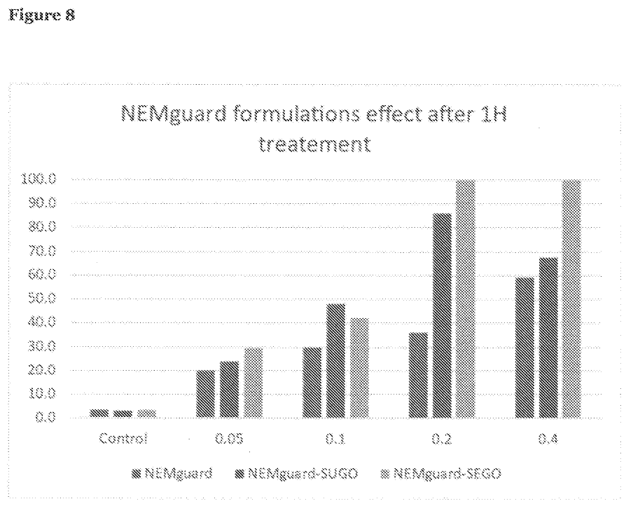

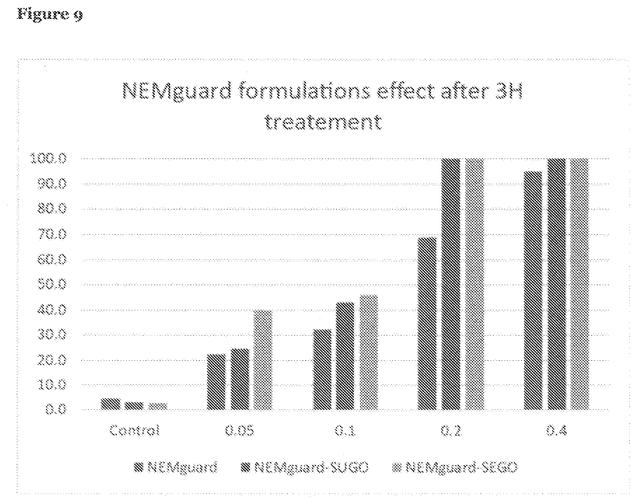

FIG. 8 shows the mean nematode mortality at 1 hour of contact and FIG. 9 shows the mean nematode mortality at 3 hours contact. It can be seen from FIG. 8 that there is a more rapid cytotoxic effect at one hour from the PK03 emulsions starting at 0.2% dilution. The presence of the sucrose ester introduces an even greater effect (Nemguard-SEGO).

At 3 hours contact (FIG. 9), both PK03 emulsions produced 100% mortality at 0.2% dilution. At the same concentration the Nemguard SC control at 0.2% v/v dilutions was just less than 70%. These results again show that the PK03 formulations are more active at lower dilutions than Nemguard SC control.

The clear increase in biological activity from PK03 over NEMguard SC appears to correlate with the emulsification process increasing droplet surface area through production of smaller diameter droplets in the PK03 formulations. It is hypothesised that the natural emulsifiers in Nemguard SC can provide a similar level of stability to the PK03 emulsions but cannot generate the smaller droplet sizes seen in the PK03 emulsions which seem to transfer more active to the target and hence increase the biological activity.

The emulsions produced herein can be incorporated into solid formulations, such as granules, which provides advantages over purely liquid spray systems.

For example, unlike liquid spray systems, granules themselves are not washed away with water and remain active within the soil over a long period of time. Secondly, the granule composition can be tailored to provide a release rate suitable for the particular active ingredient and target pest. It has been surprisingly found that emulsions described above retain their activity even when incorporated into a granule. Moreover, the provision of the active compounds enhances the performance of granules containing an equivalent amount of non-emulsified active.

In summary, an emulsion in accordance with the description above is prepared. The emulsion is then mixed into the carrier matrix of the granule by sequential addition of the emulsion to the carrier matrix in a coating pan until the desired volume of emulsion has been added and a well formed pellet results. The ratio of emulsion to carrier matrix varies with the particular carrier matrix used. For example, where wood flour is the carrier matrix then the % w/w mixture ratio can be 45:55 emulsion:wood flour. For a diatomaceous earth carrier, then a ratio of 25:75 is typical.

A typical granule matrix is wood flour having a granule size of from 1.5-2.5 mm. However the carrier matrix can be selected from wood flour, diatomaceous earth or Biodac™, a cellulosic material (47-53%) containing predominantly calcium carbonate (14-20%) and kaolin clay (28-34%), along with titanium dioxide (less than 1%).

The incorporation of garlic oil into granules is known but the percentage of active ingredient released by water flow is usually no higher than 15% of the total amount contained in the granule even after repeated elutions. Again, without being bound by theory, it is likely that the polysulphides remain in the granule, which tend to be those of higher sulphur chain length, are quite strongly bound within the granule and are also relatively insoluble in water. An object of including emulsions of the active is therefore to improve the overall percentage release. In general, results achieved show a 10 to 20-fold increase in release of active polysulphide from granules prepared from emulsions.

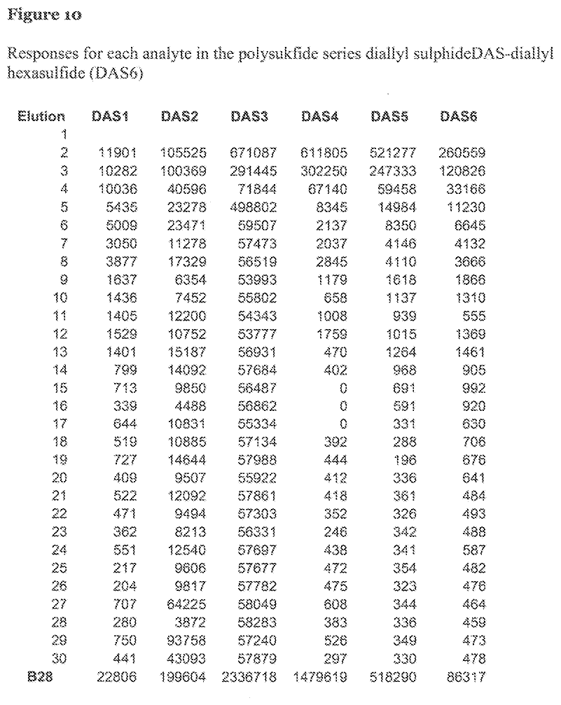

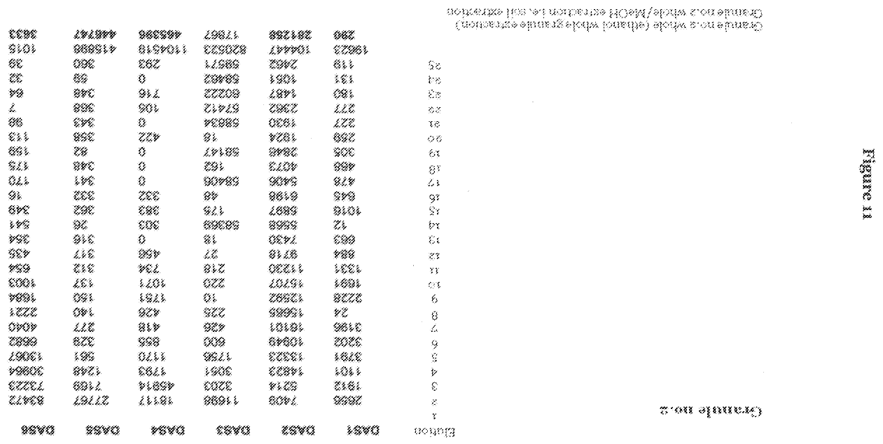

This is exemplified in the results below in FIGS. 10 and 11. As elsewhere DAS in the specification stands for diallylsulphane and the numeral designates the S chain length within the molecule. In these experiments, the release profile of polysulphide from granules was explored. Granules were compared and water passed repeatedly therethrough.

In the experiment the granules were mixed in equal weight proportions with Celite 545 (a silica carrier made from diatomaceous earth calcined with flux material) and the mixture loaded into a syringe barrel. The lower end of the syringe barrel has a layer of glass wool to precent granules falling through the hub of the syringe. Once the mixture is loaded further glass wool is inserted over this. Water in discrete 15 ml aliquots is eluted through the barrel (test cell) and the fractions collected for bioassay. The first aliquot is not usually recovered due to absorption.

The eluted water was analysed by HPLC to determine the relative amount and type of polysulphide released into the water.

The granules employed in FIG. 10 were a single core wood cellulose granule, mixed with a processed garlic oil (prepared from whole plant extract) emulsified into the disperse phase, with water as the continuous phase. The emulsifying agent was 2% Tween™ 20: the Tween™ 20 being added to the garlic oil prior to emulsification.

The granules employed in FIG. 11 utilise a liquid matrix comprising 25% w/w sucrose and 5% w/w polysulphide. These granules were included in order to investigate the effect of using a non-esterified carbohydrate.

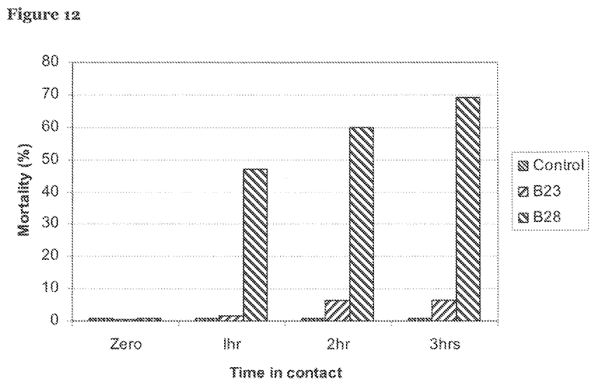

Comparison of FIGS. 10 and 11 shows a tenfold greater release of polysulphide from the granules formed using the emulsion. These results are reflected in the nematicidal effects of the eluted fraction taken from cycle 2 of each granule type above, as shown in FIG. 12. In these experiments, bioassays were carried out whereby 0.9 ml of eluted material from cycle 2, was transferred to an Epindorf tube. Water (100 μl), containing 250 to 350 fresh nematodes, was then added to the Epindorf tube which was then closed and gently mixed. Immediately, and at hourly intervals thereafter, 50 μl aliquots were removed and tested to determine the mortality of the nematodes. A control using water was also included.

The results presented in FIG. 12 show mortality rate versus time. The granules prepared using a polysulphide emulsion (B28) can be seen to have a vastly increased effect on the mortality of the nematodes, presumably related to the greater release.

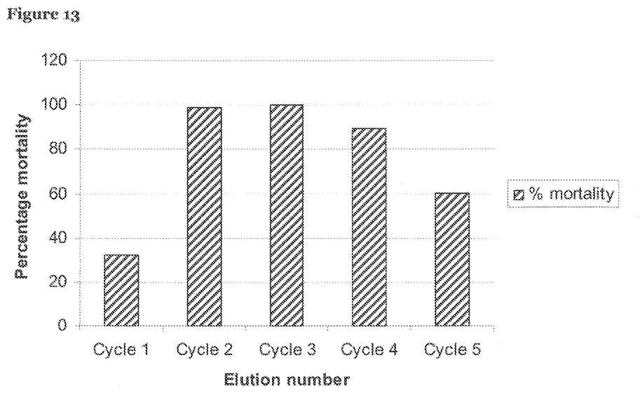

As further evidence of the efficacy of the eluted material from the granules prepared from emulsified material, the nematicidal effects of the first five elutes (as detailed in FIG. 10) are shown in FIG. 13. In this experiment the eluted material was in contact with the nematodes for 18 hours.

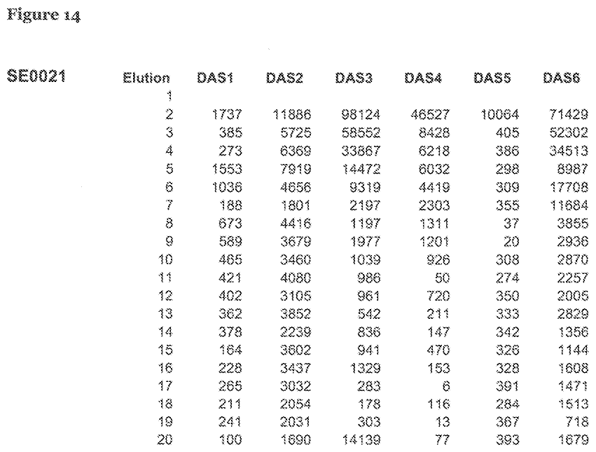

In a further experiment, granules were prepared using a synthetic polysulphide oil emulsified in water using a sucrose ester (SP70) at a level of 3% weight for weight and a level of 4% weight for weight polysulphide oil. The elution patterns for this compound are shown in FIG. 14.

The efficacy of a granular carrier for emulsified active in soil was also determined. An emulsion was formed using moderate sheer of garlic oil concentrate in water using 1% w/w Tween™ 20 as added surfactant. The emulsion thereby produced was sprayed into the granule build process to produce the carrier.

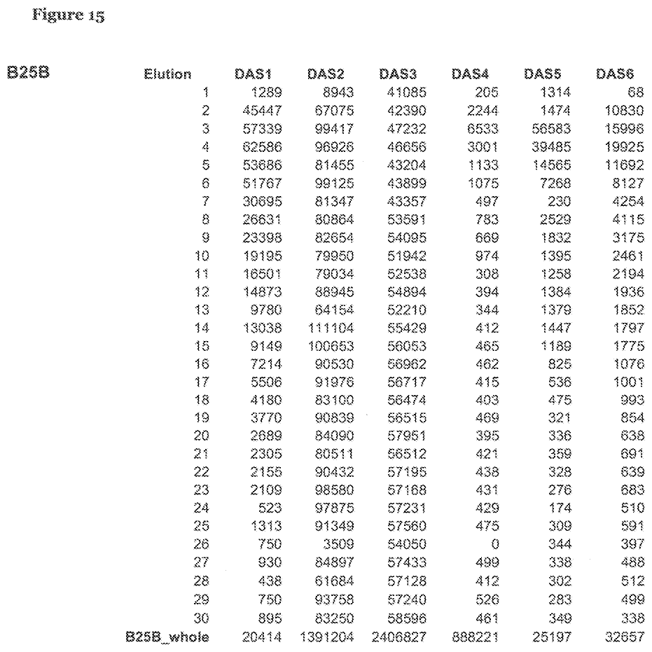

Granules produced were mixed with soil and eluted once per day over a fifteen day period. The sequential fractions were collected and analysed for polysulfide concentration. The elution profile is shown in FIG. 15. As can be seen, almost all of the polysulfide released appears by the end of day 4. In vitro tests with this granule through Celite™ 545 indicated high direct nematicidal on vermiform Nematodes (J2 s). It should be noted that the concentrations of polysulfides at cycles 2 to 4 are tenfold more than seen for granules of a commercially available granule containing concentrated garlic oil, which has been shown to have demonstrable activity in soil.

A field trial was carried out on behalf of the applicant by ORETO (Official Recognition of Efficacy Testing Organisations and facilities) certified contract trials agents. The trial was carried out in Lincolnshire, in a typical silt soil.

An emulsion according to the present disclosure was made using natural garlic extract. In addition, an emulsion was made according to the present disclosure comprising a synthetic formulation with the same gravimetric polysulfide oil composition as the natural garlic oil product 12 L of the natural garlic extract. This product was based around water, polysorbate 20 and polysulfide oil mixed to an emulsion. The treatments were applied, over a comparable area in each case, to a field with potato crop nematode present, as follows:
Control (no application);
Device control (injector with water);
6 L/ha dose of natural garlic emulsion delivered via injector;
12 L/ha dose of natural garlic emulsion delivered via injector;
24 L/ha dose of natural garlic emulsion delivered via injector;
12 L/ha dose of synthetic emulsion delivered via injector;
Nemathorin® (Syngenta), a commercially available registered nematicide containing fosthiazate for the control of potato cyst nematode, was applied at the recommended dose.

### Results

Gross yield recovered from the field; and mean final PCN population (determined as eggs/gram of soil) is shown in Table 2, below.

TABLE 2

| | Mean Final PCN | |
|---|---|---|
| | Population | Yield |
| Untreated | 594.76 | 57.61 |
| Device Control | 297.59 | 55.4 |
| 6 L natural garlic emulsion | 307.02 | 55.91 |
| 12 L natural garlic emulsion | 293.5 | 54.14 |
| 24 L natural garlic emulsion | 180.7 | 58.21 |
| 12 L Synthetic emulsion | 183.56 | 58.09 |
| Nemathorin ® | 67.99 | 56.44 |

These results demonstrate the effectiveness of emulsions according to the present disclosure. The application of 24 L of natural emulsion and 12 L of synthetic emulsion increased yield, by a comparable amount, relative to the untreated control, the device control and the commercially available nematicide, Nemathorin®.

In addition, the application of 24 L of natural emulsion and 12 L of synthetic emulsion decreased final PCN population, by a comparable amount, relative to the untreated control and the device control, thus demonstrating a nematicidial effect.

These results indicate that on a dose to dose comparison, the synthetic emulsion may demonstrate greater efficacy than the natural product.

It has also surprisingly been discovered that the biopesticide emulsions described herein can have an effect of accelerating breaking of bud dormancy.

Bud dormancy is a process in which plant meristems become mostly inactive. The purpose of this is to allow the plant to withstand harsh environmental conditions. Various types of environmental stimuli can induce bud dormancy. Similarly, various types of environmental stimuli can break bud dormancy including changes in temperature or day length. However, climate change has had an impact of bud dormancy and breaking of bud dormancy, warmer autumn, winters and springs impacts breaking of bud dormancy in particular which affects the timing an intensity of growth resumption and bloom progression.

The effect of the PK03 (Nature Identical Product (NIP)) emulsions in changing bud breaking were investigated compared to an untreated control and the results are shown in Table 3. The PK03 emulsions had the same composition as outlined above.

TABLE 3

| April 2023 | | | | | | | | | | | |
|---|---|---|---|---|---|---|---|---|---|---|---|
| | No of | No | % | | | | | | | | |
| | detected | open | open | Phenological stage: sprouting % BBCH | | | | | | | |
| Treatment | buds | buds | bud | 0 | 1 | 3 | 5 | 8 | 11 | 13 | 15 |
| Control | 472 | 434 | 91.9 | 8.1 | 5.5 | 9.5 | 27.5 | 33.9 | 14.0 | 1.5 | 0.0 |
| NIP | 483 | 452 | 93.6 | 6.4 | 3.9 | 11.2 | 22.6 | 36.2 | 16.4 | 3.3 | 0.0 |
| 1.0 L/ha | | | | | | | | | | | |
| NIP | 469 | 440 | 94.4 | 5.6 | 0.9 | 9.9 | 18.0 | 36.7 | 21.7 | 7.3 | 0.0 |
| 2.5 L/ha | | | | | | | | | | | |
| NIP | 478 | 461 | 96.4 | 3.6 | 0.6 | 8.4 | 16.9 | 32.8 | 27.4 | 7.5 | 2.1 |
| 5.0 L/ha | | | | | | | | | | | |
| ERGER* | 480 | 458 | 95.4 | 4.6 | 1.7 | 8.3 | 19.0 | 36.3 | 23.8 | 6.3 | 0.0 |
| Active | | | | | | | | | | | |
| ERGER** | | | | | | | | | | | |

*urea based product
**mineral activator

All the above applications were made on 1 Feb. 2023 which was 60-days prior to anticipated bud breaking. The results show a much higher population of open shoots in the advanced BBCH (11-13) from all the NIP doses relative to the untreated. BBCG is the scale used to identify the phenological development stages of plants.

Approximately 35% of the of open shoots were in BBCH 11-13 from a 5 L/ha application, compared to 15.5% in the untreated.

The biochemical process associated with breaking bud dormancy are very complex and only just being elucidated in any detail. However, one key factor in bringing a plant bud into dormancy and subsequently releasing the bud dormancy is the level and duration of oxidative stress in the cells and tissues of the bud and how this affects mitochondrial activity (the cellular powerhouse). Concentrations of low molecular weight thiols especially glutathione (GSH) are believed to play a crucial role in holding plant tissues in a dormant state as GSH is a key regulator of cellular Redox potential. As the GSH pool decreases over time (under winter conditions) oxidative stress slowly develops to a point where possibly a critical Redox value is reached, and triggers increases in metabolic activity and the activation of mitochondria to produce energy to break dormancy and start growth in new buds.

The polysulfides in PK03 are known to react with GSH depleting concentrations and generate oxidative stress and are thought therefore to affect mitochondrial activity in a manner that breaks bud dormancy.

### Aspects

Set forth below are non-limiting aspects of the present disclosure.

1. An emulsion system having a first continuous phase comprising water and a second discontinuous phase comprising a biopesticide derived from a concentrated liquid garlic juice, a synthetic polysulphane or mixture thereof, and including an emulsifying agent to retain the two phase system.

2. An emulsion system according to aspect 1, wherein the diameter of the emulsion droplets of the discontinuous phase are less than 2.4 μm.

3. An emulsion system according to aspect 2, wherein the diameter is less than 2.0 μm, less than 1.5 μm, less than 1.3 μm or about 1 μm.

4. An emulsion system according to any preceding aspect, wherein the emulsion as a specific surface area of more than 200,000 cm²/mL.

5. An emulsion system according to aspect 4, wherein the specific surface area is more than 250,000 cm²/mL, more than 300,000 cm²/mL or more than 350,000 cm²/mL.

6. An emulsion system according to any preceding aspect, wherein the emulsifying agent is an esterified carbohydrate.

7. An emulsion system according to aspect 6, wherein the carbohydrate is sorbitan.

8. An emulsion system according to aspect 7, wherein the sorbitan ester is polyethoxylated to increase the HLB value.

9. An emulsion system according to any one of aspects 1 to 5, wherein the emulsifying agent is Tween® 20.

10. An emulsion system according to any preceding aspect, wherein the emulsifying agent is present at less than 3% w/w of the emulsion system, or less than 2% w/w.

11. An emulsion system according to any preceding aspect, wherein the emulsifying agent is present at greater than 0.25% w/w.

12. An emulsion system according to any preceding aspect, wherein the percent w/w ratio of continuous to discontinuous phase is greater than 20:1, optionally, wherein the ratio is greater than 30:1.

13. An emulsion system according to any preceding aspect, for use as a biopesticide.

14. An emulsion system according to any preceding aspect, for accelerating breaking of bud dormancy.

15. A granular composition comprising a granular matrix, said granular matrix retaining an emulsion having a first continuous phase comprising water and a second discontinuous phase comprising a biopesticide derived from a concentrated liquid garlic juice, a synthetic polysulphane or mixture thereof, and including an emulsifying agent to retain the two phase system.

16. A granular composition according to aspect 15, wherein the diameter is less than 2.4 μm.

17. A granular composition according to aspect 16, wherein the diameter is less than 2.0 μm, less than 1.5 μm, less than 1.3 μm or about 1 μm.

18. A granular composition according to any one of aspects 15 to 17, wherein the biopesticide emulsion has a specific surface area of more than 200,000 cm²/mL.

19. A granular composition according to aspect 18, wherein the specific surface area is more than 250,000 cm²/mL, more than 300,000 cm²/mL or more than 350,000 cm²/mL.

20. A granular composition according to any of aspects 15 to 19, wherein the emulsifying agent is an esterified carbohydrate.

21. A granular composition according to aspect 20, wherein the carbohydrate is sorbitan.

22. A granular composition according to aspect 21, wherein the sorbitan ester is polyethoxylated to increase the HLB value.

23. A granular composition according to any one of aspects 15 to 19, wherein the emulsifying agent is Tween™ 20.

24. A granular composition according to any of aspects 15 to 23, wherein the emulsifying agent in the emulsion is present to less than 3% w/w or less than 2% w/w of the emulsion.

25. A granular composition according to any one of aspects 15 to 24, where in the emulsifying agent is present to greater than 0.25% w/w.

26. A granular composition according to any of aspects 15 to 25, wherein the percent w/w ratio of continuous to discontinuous phase of the emulsion is greater than 20:1, or is greater than 30:1.

27. A granular composition according to any of aspects 15 to 26, wherein the emulsion is present at a ratio from 0.5-1.0% w/w to the granular matrix.

28. A granular composition according to any of aspects 15 to 27, wherein the granular matrix is selected from a diatomaceous earth or a cellulosic material preferably, wherein the granular matrix is a wood cellulose.

29. A granular composition according to any one of aspects 15 to 28, for use as a pesticide.

30. A method of manufacture of a granular composition comprising the steps of:
producing an emulsion of a biopesticide in water;
selecting a granular matrix material and;
mixing said emulsion with the granular matrix material to absorb the emulsion within the matrix;
   wherein the biopesticide is derived from a concentrated liquid garlic juice, a synthetic polysulphane or mixture thereof.

31. The method of aspect 29, wherein production of the emulsion comprises a step of blending at a speed of at least 2000 rpm, at least 3000 rpm, at least 4000 rpm, at least 6000 rpm or at least 8000 rpm; or at a speed of about 3000 rpm, about 4000 rpm, about 6000 rpm or about 8000 rpm.

32. The use of a granular composition, wherein the granular composition includes a granular matrix and an emulsified biopesticide absorbed within said matrix wherein the biopesticide is derived from a concentrated liquid garlic juice, a synthetic polysulphane or mixture thereof.

33. The use according to aspect 32 as a biopesticide.

Various modifications to the embodiments of the present invention described herein will be readily apparent to those skilled in the art and such modifications are included within the scope as defined in the appended claims.

1. A biopesticide emulsion system having a first continuous phase comprising water and a second discontinuous phase comprising a biopesticide derived from a concentrated liquid garlic juice, a synthetic polysulphane or mixture thereof, and including an emulsifying agent to retain the two phase system.

2. An emulsion system according to claim 1, wherein the diameter of the emulsion droplets of the discontinuous phase are less than 2.4 μm.

3. An emulsion system according to claim 2, wherein the diameter is less than 2.0 μm, less than 1.5 μm, less than 1.3 μm or about 1 μm.

4. An emulsion system according to any preceding claim, wherein the emulsion as a specific surface area of more than 200,000 cm²/mL.

5. An emulsion system according to claim 4, wherein the specific surface area is more than 250,000 cm²/mL, more than 300,000 cm²/mL or more than 350,000 cm²/mL.

6. An emulsion system according to any preceding claim, wherein the emulsifying agent is an esterified carbohydrate.

7. An emulsion system according to claim 6, wherein the carbohydrate is sorbitan.

8. An emulsion system according to claim 7, wherein the sorbitan ester is polyethoxylated to increase the HLB value.

9. An emulsion system according to any one of claims 1 to 5, wherein the emulsifying agent is Tween® 20.

10. An emulsion system according to any preceding claim, wherein the emulsifying agent is present at less than 3% w/w of the emulsion system, or less than 2% w/w.

11. An emulsion system according to any preceding claim, wherein the emulsifying agent is present at greater than 0.25% w/w.

12. An emulsion system according to any preceding claim, wherein the percent w/w ratio of continuous to discontinuous phase is greater than 20:1, optionally, wherein the ratio is greater than 30:1.

13. An emulsion system according to any preceding claims, for accelerating breaking of bud dormancy.

14. A granular pesticide comprising a granular matrix, said granular matrix retaining a biopesticide emulsion having a first continuous phase comprising water and a second discontinuous phase comprising a biopesticide derived from a concentrated liquid garlic juice, a synthetic polysulphane or mixture thereof, and including an emulsifying agent to retain the two phase system.

15. A granular pesticide according to claim 14, wherein the diameter is less than 2.4 μm.

16. A granular pesticide according to claim 15, wherein the diameter is less than 2.0 μm, less than 1.5 μm, less than 1.3 μm or about 1 μm.

17. A granular pesticide according to any one of claims 14 to 16, wherein the biopesticide emulsion has a specific surface area of more than 200,000 cm²/mL.

18. A granular pesticide according to claim 17, wherein the specific surface area is more than 250,000 cm²/mL, more than 300,000 cm²/mL or more than 350,000 cm²/mL.

19. A granular pesticide according to any of claims 14 to 18, wherein the emulsifying agent is an esterified carbohydrate.

20. A granular pesticide according to claim 19, wherein the carbohydrate is sorbitan.

21. A granular pesticide according to claim 20, wherein the sorbitan ester is polyethoxylated to increase the HLB value.

22. A granular pesticide according to any one of claims 14 to 18, wherein the emulsifying agent is Tween™ 20.

23. A granular pesticide according to any of claims 14 to 22, wherein the emulsifying agent in the emulsion is present to less than 3% w/w or less than 2% w/w of the emulsion.

24. A granular pesticide according to any one of claims 14 to 23, where in the emulsifying agent is present to greater than 0.25% w/w.

25. A granular pesticide according to any of claims 14 to 24, wherein the percent w/w ratio of continuous to discontinuous phase of the emulsion is greater than 20:1, or is greater than 30:1.

26. A granular pesticide according to any of claims 14 to 25, wherein the emulsion is present at a ratio from 0.5-1.0% w/w to the granular matrix.

27. A granular pesticide according to any of claims 14 to 26, wherein the granular matrix is selected from a diatomaceous earth or a cellulosic material preferably, wherein the granular matrix is a wood cellulose.

28. A method of manufacture of a granular biopesticide comprising the steps of:
producing an emulsion of a biopesticide in water;
selecting a granular matrix material and;
mixing said emulsion with the granular matrix material to absorb the emulsion within the matrix;
wherein the biopesticide is derived from a concentrated liquid garlic juice, a synthetic polysulphane or mixture thereof.

29. The method of claim 28, wherein production of the emulsion comprises a step of blending at a speed of at least 2000 rpm, at least 3000 rpm, at least 4000 rpm, at least 6000 rpm or at least 8000 rpm; or at a speed of about 3000 rpm, about 4000 rpm, about 6000 rpm or about 8000 rpm.

30. The use of a granular biopesticide composition, wherein the granular biopesticide composition includes a granular matrix and an emulsified biopesticide absorbed within said matrix wherein the biopesticide is derived from a concentrated liquid garlic juice, a synthetic polysulphane or mixture thereof.
